(19) United States
(12) Patent Application Publication
(10) Pub. No.: US 2015/0244071 A1
(43) Pub. Date: Aug. 27, 2015

(54) WIRELESS COMMUNICATION DEVICE AND DIRECTIVITY CONTROL METHOD

(71) Applicant: Panasonic Corporation, Osaka (JP)

(72) Inventors: NAGANORI SHIRAKATA, Kanagawa (JP); HIROYUKI MOTOZUKA, Kanagawa (JP)

(21) Appl. No.: 14/625,625

(22) Filed: Feb. 18, 2015

(30) Foreign Application Priority Data
Feb. 24, 2014 (JP) 2014-033042

(51) Int. Cl. H01Q 3/34; H04W 24/08

(52) U.S. Cl. CPC H01Q 3/34; H04W 24/08

(57) ABSTRACT

A wireless communication device includes a directivity control unit that sets a directivity for a plurality of antennas, a directivity switching unit that switches the directivity for the plurality of antennas, and a reception quality estimation unit that measures the reception quality of a received signal received by the plurality of antennas. The directivity control unit uses the reception quality of a received signal directed to another station among the received signals to set the directivity in a direction in which an influence of interference from the other station is reduced.

### BACKGROUND

1. Technical Field

The present disclosure relates to a wireless communication device that has an antenna directivity and a directivity control method for the wireless communication device.

2. Description of the Related Art

Recently, the study of wireless communication standards using radio frequency bands has been promoted; for example, the wireless personal area network (PAN) standard, IEEE 802.15.3c, and the wireless local area network (LAN) standard, IEEE 802.11ad, have been established as standards using a millimeter-wave band of a 60-GHz band.

A millimeter-wave band has radio characteristics of high straightness and large spatial attenuation, and therefore a beamforming technique is used in which a plurality of antennas are used to control directivities for wireless communication in the millimeter-wave band. Protocols for beamforming have been stipulated also in the above IEEE 802.15.3c and IEEE 802.11ad standards. However, a specific directivity control method for determining which directivity should be selected is implementation-dependent.

Known beamforming training techniques in the related art for controlling directivities include techniques in Japanese Unexamined Patent Application Publication (Translation of PCT Application) No. 2012-524495, Japanese Patent No. 5302024, and Japanese Patent No. 5096576.

### SUMMARY

Conventionally, there is a problem of difficulty in appropriate directivity control if interference from another device occurs.

One non-limiting and exemplary embodiment provides a wireless communication device capable of autonomous interference avoidance in consideration of interference from another device.

In one general aspect, the techniques disclosed here feature a wireless communication device that includes a directivity control unit that sets a directivity for a plurality of antennas, a directivity switching unit that switches the directivity for the plurality of antennas, and a reception quality estimation unit that measures the reception quality of a received signal received by the plurality of antennas. The directivity control unit uses the reception quality of a signal directed to another station to adjust the directivity in a direction in which an influence of interference from the other station is reduced.

The present disclosure enables autonomous interference avoidance in consideration of interference from another device.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a schematic configuration of a wireless communication system including a plurality of wireless communication devices that perform directivity control;

FIG. 2 is a block diagram illustrating a configuration of a wireless communication device for use in an access point and a terminal station;

FIG. 3 is a block diagram illustrating an example of a configuration of a directivity switching unit;

FIG. 4 is a block diagram illustrating another example of a configuration of the directivity switching unit;

FIG. 5 illustrates an example of a phase table;

FIGS. 6A and 6B illustrate beam patterns corresponding to directivity pattern information, with FIG. 6A illustrating an example of a beam pattern corresponding to a sector number and FIG. 6B illustrating an example of a beam pattern corresponding to a pattern number;

FIG. 7 is a flowchart illustrating an operating procedure for directivity setting before the start of communication in a wireless communication device of a present embodiment;

FIG. 8 is a flowchart illustrating an operating procedure for a transmitting sector directivity determination on the access point side in step S602 of FIG. 7;

FIG. 9 is a flowchart illustrating an operating procedure for a transmitting sector directivity determination on the terminal station side in step S603 of FIG. 7;

FIG. 10 is a flowchart illustrating an operating procedure for a receiving sector directivity determination on the access point side in step S604 of FIG. 7;

FIG. 11 is a flowchart illustrating an operating procedure for a receiving sector directivity determination on the terminal station side in step S605 of FIG. 7;

FIG. 12 illustrates time-series changes in the packet switching and directivity when a transmitting sector directivity determination is made during an SLS period of a local station;

FIG. 13 illustrates time-series changes in the packet switching and directivity when a receiving sector directivity determination is made during the SLS period of the local station; and

FIG. 14 illustrates time-series changes in the packet switching and directivity when intra-sector directivity control is performed during an SLS period of another station.

### DETAILED DESCRIPTION

### Underlying Knowledge Forming Basis of Embodiments of the Present Disclosure

Before the description of embodiments of a wireless communication device and a directivity control method according to the present disclosure, problems with directivity control upon occurrence of interference from another device will first be described.

Japanese Unexamined Patent Application Publication (Translation of PCT Application) No. 2012-524495 above discloses a technique for performing beamforming training using fixed slots. However, in Japanese Unexamined Patent Application Publication (Translation of PCT Application) No. 2012-524495, the link quality is determined by a packet from a communication counterpart, without consideration of interference due to a signal transmitted from a source other than the communication counterpart.

Japanese Patent No. 5302024 discloses a technique in which a plurality of base stations cooperate to control terminal directivities. However, in Japanese Patent No. 5302024, although inter-cell interference is considered, it is necessary to create a large-scale configuration for providing notification of interference information among the plurality of base stations.

Japanese Patent No. 5096576 discloses a technique for avoiding interference in a peer-to-peer network by performing beamforming. However, in Japanese Patent No. 5096576, it is required that communication can be performed also with an interference source other than a communication counterpart in message switching for interference avoidance.

Conventionally, a problem in performing directivity control in consideration of interference is that devices have a large size or a communication protocol has large overhead.

In order to address the above problems, the present disclosure gives examples below of a wireless communication device and a directivity control method that perform autonomous interference avoidance with small overhead when an antenna directivity is controlled in wireless communication.

### Embodiment of the Present Disclosure

An embodiment according to the present disclosure will now be described in detail with reference to the drawings. For the drawings used for the following description, the same components are given the same reference numerals and repeated descriptions are omitted.

### Schematic Configuration of a Wireless Communication System

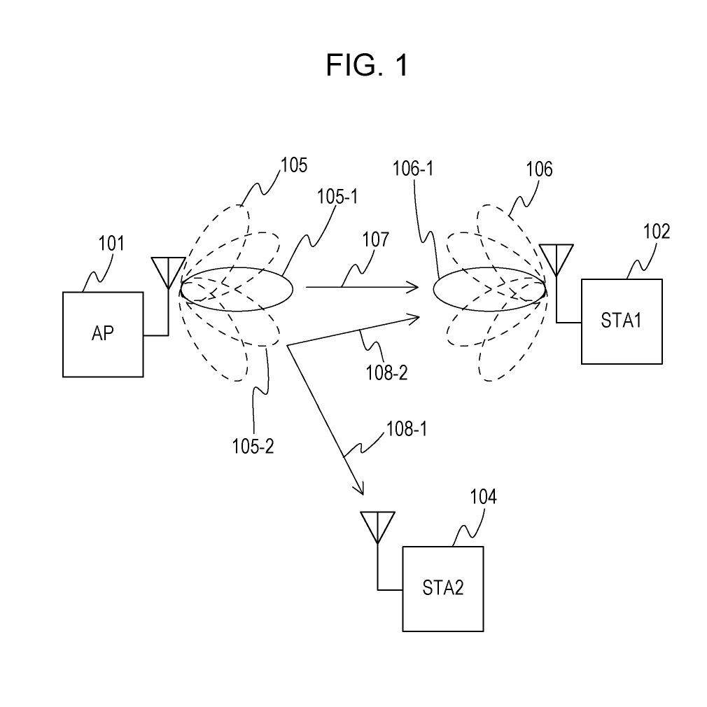

FIG. 1 illustrates a schematic configuration of a wireless communication system including a plurality of wireless communication devices that perform directivity control.

The wireless communication system includes an access point (AP) 101, a first terminal station (STA1) 102, and a second terminal station (STA2) 104. Each of the access point 101 and the terminal stations 102 and 104 is a wireless communication device that controls transmitting and receiving directivities and performs wireless communication. The access point 101 and the terminal stations 102 and 104 have directive antennas, and perform communication by selecting a beam pattern suitable for a communication counterpart from a plurality of beam patterns.

The access point (AP) 101 is referred to below as an access point AP, the first terminal station (STA1) 102 as a terminal station STA1, and the second terminal station (STA2) 104 as a terminal station STA2.

The present disclosure assumes a situation in which the terminal station STA1 and the terminal station STA2 each communicate with the access point AP. Synchronous communication is performed between the access point AP and the terminal station STA1 and between the access point AP and the terminal station STA2 within a single network. The following will focus on the communication between the access point AP and the terminal station STA1.

In FIG. 1, a wireless signal 107 is a desired wave signal transmitted from the access point AP to the terminal station STA1, and a wireless signal 108-1 is a desired wave signal transmitted from the access point AP to the terminal station STA2. An interference signal 108-2 is an interference wave signal which is a wireless signal from the access point AP to the terminal station STA2 arriving at the terminal station STA1 as interference.

The access point AP can set a plurality of beam patterns 105 through directivity control. The terminal station STA1 can set a plurality of beam patterns 106 through directivity control.

For example, the access point AP selects a beam pattern 105-1 denoted by a solid line from among the beam patterns 105, the terminal station STA1 selects a beam pattern 106-1 denoted by a solid line from among the beam patterns 106, and communication is performed. On the other hand, for communication with the terminal station STA2, the access point AP selects, from among the beam patterns 105, a beam pattern 105-2 denoted by the second broken line from the bottom. The beam pattern 105-2 is selected because a wireless signal 108-1 in the direction of the terminal station STA2 has the highest reception quality, for example, has a high reception level.

When the access point AP and the terminal station STA1 are communicating by the wireless signal 107 and the access point AP and the terminal station STA2 are communicating by the beam pattern 105-2, radio waves are emitted in a direction other than the direction of the wireless signal 108-1, and therefore a wireless signal directed to the terminal station STA2 is emitted also in the direction of the terminal station STA1.

For the terminal station STA1, the wireless signal directed to the terminal station STA2 is not a signal directed to the local station, and therefore is received as the interference signal 108-2. Although FIG. 1 illustrates an example in which the terminal station STA1 is receiving the signal, interference occurs in each of combinations of the access point AP, the terminal station STA1, and the terminal station STA2. A status of interference from another station varies depending on the distance and location of each wireless communication device, but reflection of radio waves may cause wireless signals to propagate over a plurality of paths and interference waves may arrive from a plurality of directions in addition to the line-of-sight direction between the local station and the other station.

### Configuration of a Wireless Communication Device

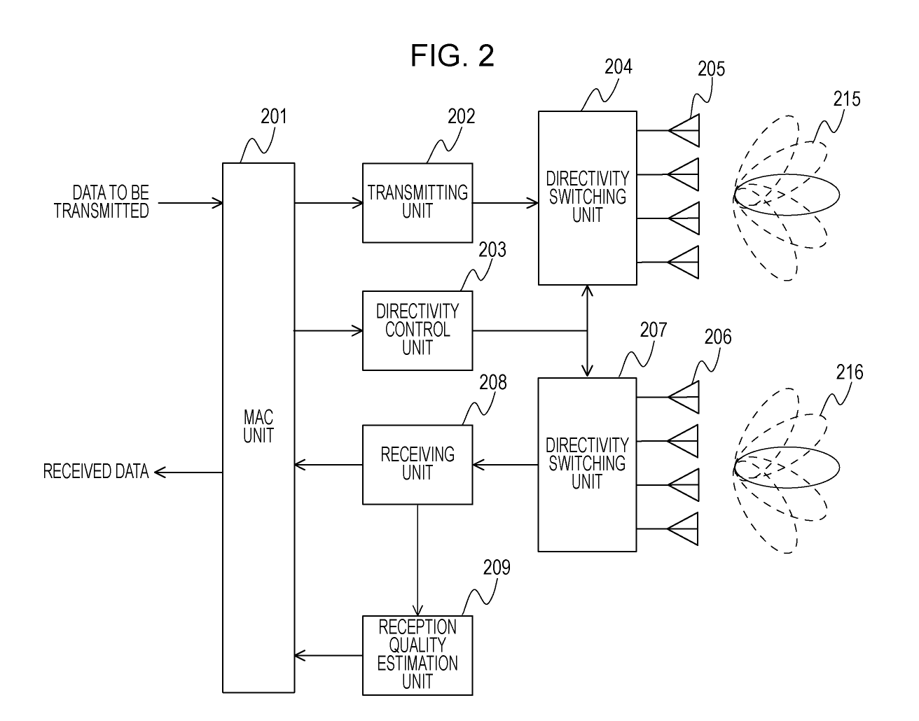

FIG. 2 is a block diagram illustrating a configuration of a wireless communication device for use in the access point 101 and the terminal stations 102 and 104.

The wireless communication device includes a media access control (MAC) unit 201, a transmitting unit 202, a directivity control unit 203, a directivity switching unit 204 on the transmission side, a transmitting antenna 205, a receiving antenna 206, a directivity switching unit 207 on the reception side, a receiving unit 208, and a reception quality estimation unit 209.

The wireless communication device uses the plurality of transmitting antennas 205 to transmit a wireless signal through any of a plurality of beam patterns 215, and uses the plurality of receiving antennas 206 to receive a wireless signal through any of a plurality of beam patterns 216.

FIG. 2 illustrates a configuration that has the directivity switching unit 204 on the transmission side and the directivity switching unit 207 on the reception side separately, and the transmitting antennas 205 and the receiving antenna 206 separately. However, a configuration may be created to have one directivity switching unit and one set of antennas for shared use in transmission and reception.

For transmission by the wireless communication device, when data to be transmitted is input to the MAC unit 201, the MAC unit 201 controls a transmission timing and frames the data to be transmitted in accordance with a communication protocol, and outputs the data frame to the transmitting unit 202.

The MAC unit 201 decides a transmitting directivity appropriate to a communication counterpart and notifies the directivity control unit 203 of the transmitting directivity. The directivity control unit 203 outputs, to the directivity switching unit 204, directivity pattern information for setting the decided transmitting directivity.

The transmitting unit 202 performs packetization for transmission by performing, for example, coding, signal modulation, and preamble addition in the data frame in accordance with a physical layer format, and outputs the packet to the directivity switching unit 204.

The directivity switching unit 204 performs frequency conversion of the signal to be transmitted that is packetized for transmission into a radio frequency signal suitable for wireless communication. Then, the directivity switching unit 204 controls the amplitude and phase of the signal to be transmitted for transmission through a beam pattern selected from among the plurality of beam patterns 215, based on the directivity pattern information from the directivity control unit 203, and transmits the signal from the plurality of transmitting antennas 205.

For reception by the wireless communication device, the MAC unit 201 controls a reception timing and starts reception processing. The MAC unit 201 decides a receiving directivity appropriate to a communication counterpart and notifies the directivity control unit 203 of the receiving directivity. The directivity control unit 203 outputs, to the directivity switching unit 207, directivity pattern information for setting the decided receiving directivity.

The directivity switching unit 207 controls the amplitude and phase of the received signal from the plurality of receiving antennas 206 for reception with a beam pattern selected from among the plurality of beam patterns 216, based on the directivity pattern information from the directivity control unit 203. Then, the directivity switching unit 207 performs frequency conversion into a frequency band suitable for signal processing by the receiving unit 208.

The receiving unit 208 performs, for example, preamble detection, frequency synchronization, symbol synchronization, signal demodulation, and data frame decoding in the received packet for the received signal subjected to frequency conversion in accordance with the physical layer format. The receiving unit 208 data-frames a bit sequence after decoding and outputs the data frame to the MAC unit 201. The MAC unit 201 retrieves received data from the received data frame.

The reception quality estimation unit 209 estimates the reception quality of the received signal, mainly using a known patter of the preamble. As the reception quality estimated by the reception quality estimation unit 209, various signal quality indicators are used, including, for example, a reception level, received signal strength indicator (RSSI), signal to noise ratio (SNR), signal to interference and noise ratio (SINR), channel impulse response, and noise level.

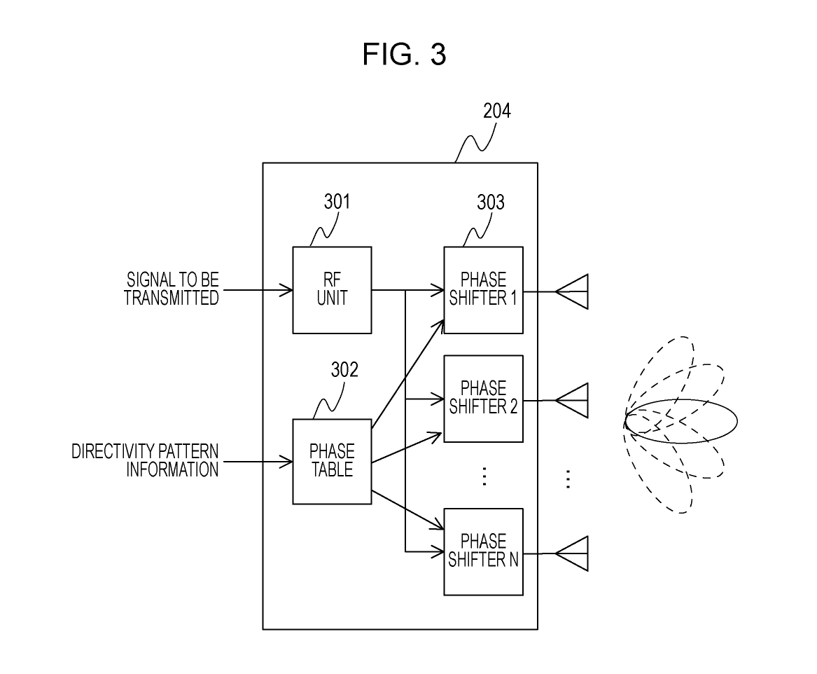

FIG. 3 is a block diagram illustrating an example of a configuration of the directivity switching unit 204. The directivity switching unit 204 includes a radio frequency (RF) unit 301, a phase table 302, and a plurality of phase shifters (phase shifters 1 to N) 303. The configuration in FIG. 3 is an example of an analog beamformer that performs phase shifting and sets a directivity for a signal in a radio frequency band.

The radio frequency unit 301 performs frequency conversion of an input signal to be transmitted into a radio frequency signal suitable for wireless communication. For example, the signal to be transmitted is a signal in a baseband, and the radio frequency signal is up-converted into a 60-GHz band of a millimeter-wave band. Alliteratively, a configuration may be created in which the signal to be transmitted is a signal in an intermediate frequency (IF) band, for example, a signal in a 5-GHz band, and the radio frequency signal is up-converted into a 60-GHz band of a millimeter-wave band. The up-converted radio frequency signal is distributed and input to the plurality of phase shifters 303.

The phase shifters 303 set the phase and/or amplitude of the radio frequency signal to respective predetermined values and output the signal to each transmitting antenna 205. The set values of the phase and amplitude in each phase shifter 303 are set with setting parameters from the phase table 302. The phase table 302 outputs sector numbers and pattern numbers as the setting parameters corresponding to directivity pattern information input from the directivity control unit 203. The sector numbers and pattern numbers will be described later. The radio frequency signal subjected to phase shifting is transmitted from each transmitting antenna 205.

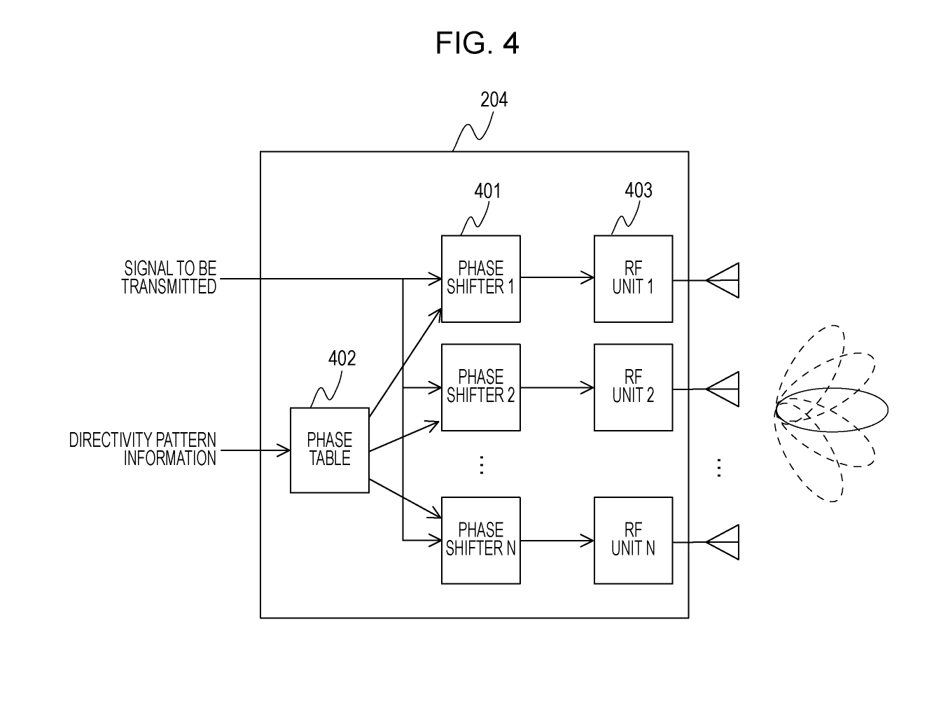

FIG. 4 is a block diagram illustrating another example of a configuration of the directivity switching unit 204. The directivity switching unit 204 includes a plurality of phase shifters (phase shifters 1 to N) 401, a phase table 402, and a plurality of radio frequency units (RF units 1 to N) 403. The configuration in FIG. 4 is an example of a digital beamformer that performs phase shifting and sets a directivity for a signal in a baseband.

An input signal to be transmitted is distributed to the plurality of phase shifters 401. The plurality of phase shifters 401 set the phase and/or amplitude of the signal before up-conversion, for example, the signal in a baseband, to respective predetermined values and output the signal to the radio frequency units 403. The set values of the phase and amplitude in each phase shifter 401 are set with setting parameters from the phase table 402. The phase table 402 outputs sector numbers and pattern numbers as the setting parameters corresponding to directivity pattern information input from the directivity control unit 203.

Each of the plurality of radio frequency units 403 performs frequency conversion of the output signal from each phase shifter 401 into a radio frequency signal suitable for wireless communication and outputs the signal, which is transmitted from each transmitting antenna 205.

FIGS. 3 and 4 illustrate configuration examples of the directivity switching unit 204 on the transmission side. However, processing may be implemented also in the directivity switching unit 207 on the reception side in a configuration in which the signal input and output directions are inverted.

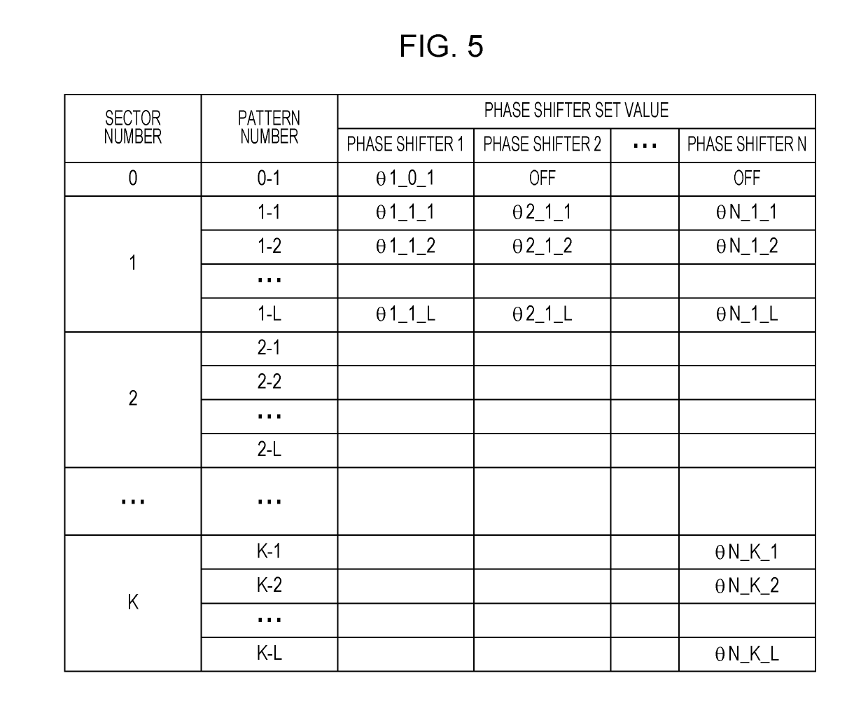

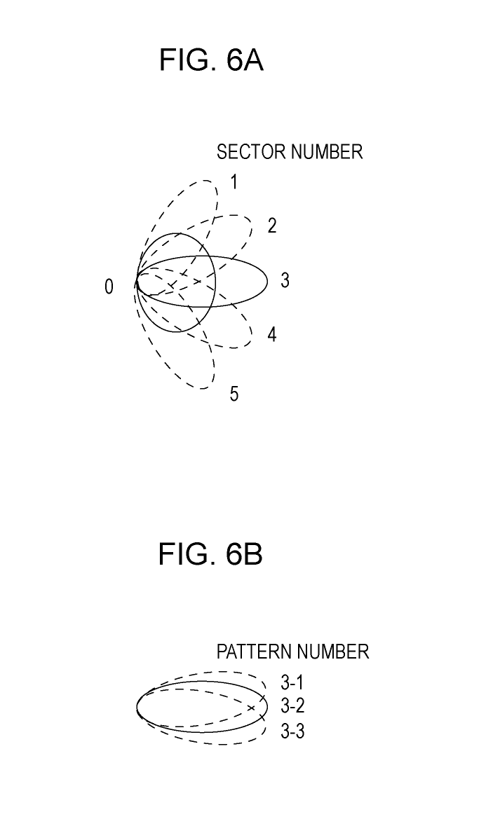

FIG. 5 illustrates an example of the phase tables 302 and 402. FIGS. 6A and 6B illustrate beam patterns corresponding to directivity pattern information, with FIG. 6A illustrating an example of a beam pattern corresponding to a sector number and FIG. 6B illustrating an example of a beam pattern corresponding to a pattern number.

A sector number decides a coarse direction of a beam pattern. For example, in FIG. 6A, five directivity patterns are set in which a main beam faces in each direction of sector numbers 1 to 5, and a quasi-omni pattern of number 0 having a nearly non-directivity characteristic is set. A pattern number provides a directivity in which the beam direction of each sector number is fine-set.

For example, sector numbers may decide directions with a spacing of 30° in a range of 150° and pattern numbers may decide directions with a spacing of ±15° around the directions of the sector numbers. The set angle spacing and set angle range for the directivity by sector numbers and the adjusted angle spacing and adjusted angle range for the directivity by pattern numbers may be arbitrarily defined as appropriate. In addition to the beam directions, a setting may be made to define the magnitude of a gain.

With the phase table, beam directivities are defined using the sector numbers and pattern numbers, and to obtain desired beam patterns, a setting parameter θ indicating the phase and amplitude to be set in each phase shifter is predefined.

When the directivity control unit 203 provides notification of the sector numbers and pattern numbers as directivity pattern information, the phase table retrieves the setting parameter θ for each phase shifter corresponding to the sector numbers and pattern numbers from, for example, a parameter table in FIG. 5, outputs the setting parameter θ to each phase shifter, and sets the phase and amplitude.

The MAC unit 201, the directivity control unit 203, and the reception quality estimation unit 209 described above may be implemented using an information processing circuit block with an integrated circuit including processors and memories or using a computer. In the information processing circuit block or computer, the relevant functions of each unit are implemented by executing a predetermined program and performing processing.

### Operation Before the Start of Communication

Before wireless communication devices including directivity control units and directivity switching units communicate with each other, beamforming training is performed to match each other's directivities. Examples of beamforming training include a sector level sweep (SLS).

In the SLS, one wireless communication device switches sectors of beam patterns and transmits or receives predetermined packets. The other receives or transmits the packets in the quasi-omni directivity and provides feedback indicating through which sector the packet having high communication quality is transmitted or received. The above procedure is performed in each transmission and reception combination, thereby matching each other's directivities between the wireless communication devices of the communication counterparts. One of the wireless communication devices starts data communication with the communication counterpart station using each other's directivity patterns decided by beamforming training.

### Directivity Control Operation in the Present Embodiment (Operation Example Applied to the SLS)

The SLS operation will now be described as an example of beamforming training with directivity control according to the present embodiment, in consideration of an interference signal from a source other than a communication counterpart station.

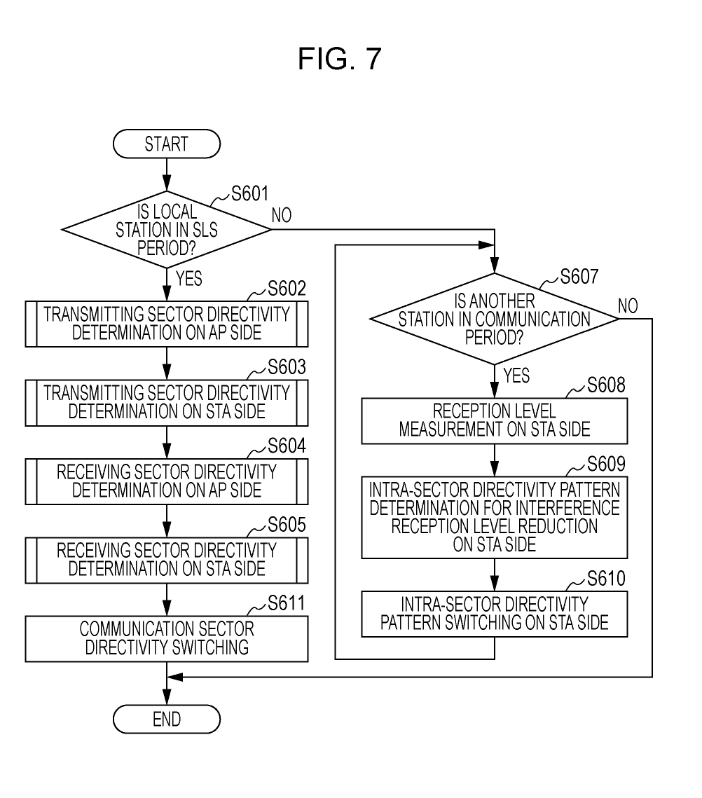

FIG. 7 is a flowchart illustrating an operating procedure for directivity setting before the start of communication in a wireless communication device of the present embodiment. For the procedure illustrated in FIG. 7, the directivity control unit 203 of the wireless communication device takes the initiative in performing processing.

First, the wireless communication device uses the MAC unit 201 to determine whether the local station is in an SLS period (step S601). Whether the local station is in the SLS period can be determined by a broadcast control signal transmitted from the access point AP. When the local station is in the SLS period, the flow proceeds to procedures in steps S602 and S603.

In step S602, the directivity control unit 203 of the wireless communication device makes a transmitting sector directivity determination on the access point AP side. In step S603, the directivity control unit 203 of the wireless communication device makes a transmitting sector directivity determination on the terminal station STA side. In the transmitting sector directivity determinations, the procedures are performed in which the wireless communication device on the transmission side switches sector numbers of beam patterns, predetermined packets are communicated, and a sector is determined which provides the highest reception level or a reception level higher than or equal to a predetermined value on the reception side.

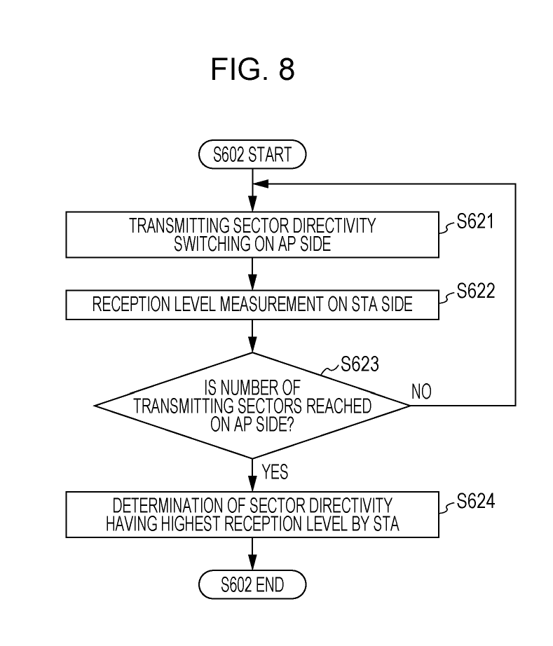

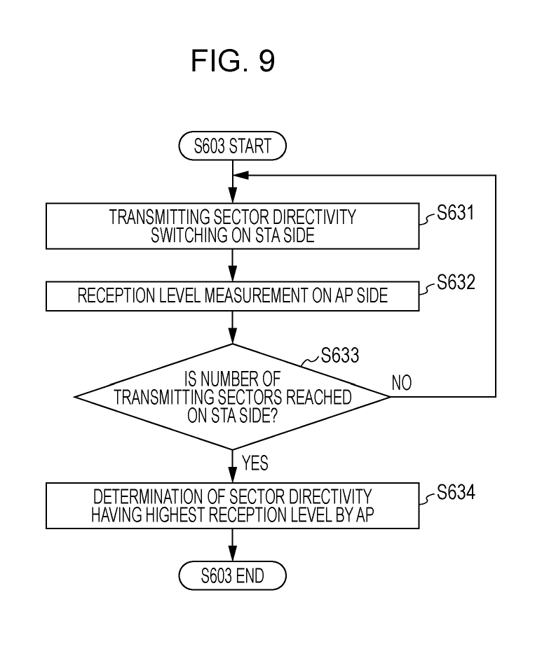

FIG. 8 is a flowchart illustrating an operating procedure for a transmitting sector directivity determination on the access point AP side in step S602 of FIG. 7. FIG. 9 is a flowchart illustrating an operating procedure for a transmitting sector directivity determination on the terminal station STA side in step S603 of FIG. 7.

In the transmitting sector directivity determination on the access point AP side in step S602, the wireless communication device on the access point AP side switches transmitting sector directivities and transmits packets (step S621), and the wireless communication device on the terminal station STA side measures reception levels of the received packets and retains the measured values (step S622). Then, whether a predetermined number of transmitting sectors switched on the access point AP side is reached is determined (step S623), and the transmitting sector switching and reception level measurement in steps S621 and S622 are repeated until the predetermined number of transmitting sectors is reached.

After the predetermined number of transmitting sectors is reached in step S623, the wireless communication device of the terminal station STA on the reception side determines a sector directivity that provides the highest reception level or a reception level higher than or equal to a predetermined value (step S624). Then, the terminal station STA notifies the access point AP of the sector number as a transmitting sector directivity determination result, and both the terminal station STA and the access point AP retain the sector number as a transmitting sector number on the access point AP side by the SLS. Thus, the transmitting sector directivity determination on the access point AP side is completed.

In the transmitting sector directivity determination on the terminal station STA side in step S603, the wireless communication device on the terminal station STA side switches transmitting sector directivities and transmits packets (step S631), and the wireless communication device on the access point AP side measures reception levels of the received packets and retains the measured values (step S632). Then, whether a predetermined number of transmitting sectors switched on the terminal station STA side is reached is determined (step S633), and the transmitting sector switching and reception level measurement in steps S631 and S632 are repeated until the predetermined number of transmitting sectors is reached.

After the predetermined number of transmitting sectors is reached in step S633, the wireless communication device of the access point AP on the reception side determines a sector directivity that provides the highest reception level or a reception level higher than or equal to a predetermined value (step S634). Then, the access point AP notifies the terminal station STA of the sector number as a transmitting sector directivity determination result, and both the access point AP and the terminal station STA retain the sector number as a transmitting sector number on the terminal station STA side by the SLS. Thus, the transmitting sector directivity determination on the terminal station STA side is completed.

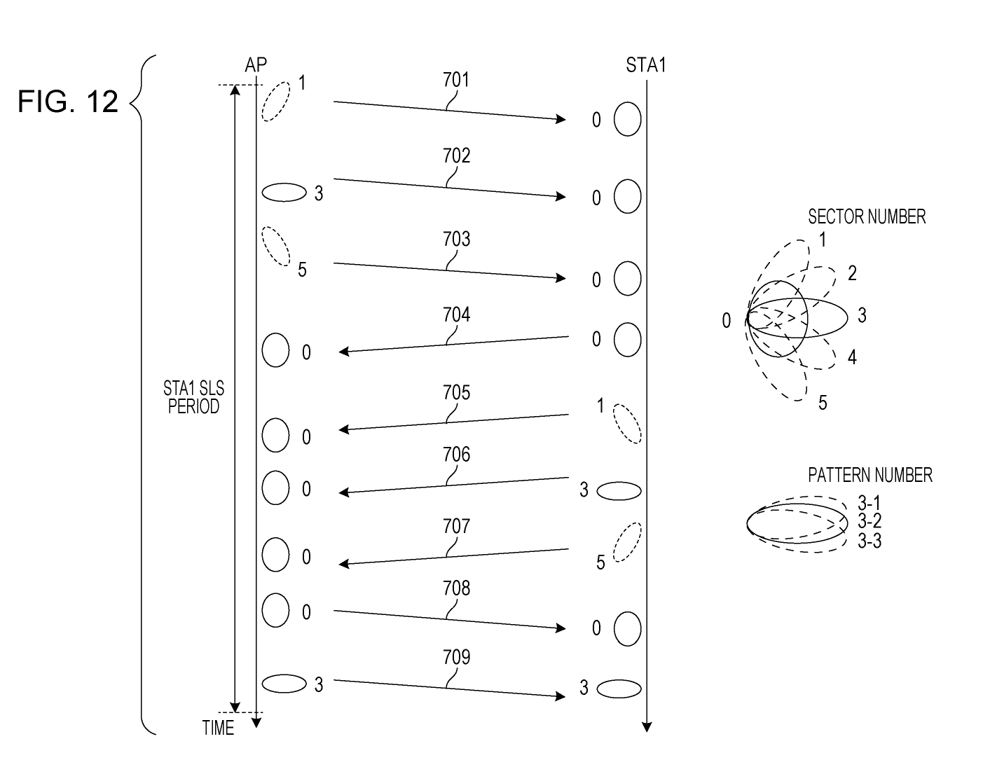

FIG. 12 illustrates time-series changes in the packet switching and directivity when a transmitting sector directivity determination is made during an SLS period of a local station. An example of the transmitting sector directivity determination operation is illustrated here when the local station is the terminal station STA1, which performs the SLS with the access point AP, which is a communication counterpart station.

In FIG. 12, the time flows from the top to the bottom, packets 701 to 709 indicate directions of transmitted packets by arrows, and which beam pattern is used for transmission or reception by each of the access point AP and the terminal station STA1 is indicated.

The selection of a sector number to be used for transmission by the access point AP will first be described. The access point AP transmits the packet 701 using the beam pattern of sector number 1. The packet 701 contains directivity pattern information that indicates which sector number is used for transmission. The terminal station STA1 receives the packet 701 using the beam pattern of sector number 0 (quasi-omni), and measures and saves the reception quality, for example, a reception level of the received packet.

Then, the access point AP transmits the packet 702 using the beam pattern of sector number 3, and the terminal station STA1 receives the packet 702 using the beam pattern of sector number 0, and measures and saves the reception quality of the received packet. Further, the access point AP transmits the packet 703 using the beam pattern of sector number 5, and the terminal station STA1 receives the packet 703 using the beam pattern of sector number 0, and measures and saves the reception quality of the received packet. The transmission and reception of the packets 701 to 703 correspond to the operation in steps S621 to S623 of FIG. 8.

The terminal station STA1 determines the packet with the highest reception quality among the above received packets and selects the best beam pattern. Alternatively, the terminal station STA1 selects the beam pattern that provides reception quality higher than or equal to a predetermined value. For example, when the packet transmitted using the beam pattern of sector number 3 has the highest reception quality, the terminal station STA1 transmits the feedback packet 704 containing directivity pattern information of sector number 3 to the access point AP using the beam pattern of sector number 0, and notifies the access point AP of the information.

The access point AP receives the feedback packet 704 using the beam pattern of sector number 0, and determines that sector number 3 is optimum in transmission on the access point AP side for packets to be transmitted from the access point AP to the terminal station STA1 (step S624 of FIG. 8).

The selection of a sector number to be used for transmission by the terminal station STA1 will next be described. First, the terminal station STA1 transmits the packet 705 using the beam patter of sector number 1. As in the above packets 701 to 703, the packet 705 contains directivity pattern information that indicates which sector number is used for transmission. The access point AP receives the packet 705 using the beam pattern of sector number 0, and measures and saves the reception quality, for example, a reception level of the received packet.

Then, the terminal station STA1 transmits the packet 706 using the beam pattern of sector number 3, and the access point AP receives the packet 706 using the beam pattern of sector number 0, and measures and saves the reception quality of the received packet. Further, the terminal station STA1 transmits the packet 707 using the beam pattern of sector number 5, and the access point AP receives the packet 707 using the beam pattern of sector number 0, and measures and saves the reception quality of the received packet. The transmission and reception of the packets 705 to 707 correspond to the operation in steps S631 to S633 of FIG. 9.

The access point AP determines the packet with the highest reception quality among the above received packets and selects the best beam pattern. Alternatively, the access point AP selects the beam pattern that provides reception quality higher than or equal to a predetermined value. For example, when the packet transmitted using the beam pattern of sector number 3 has the highest reception quality, the access point AP transmits the feedback packet 708 containing directivity pattern information of sector number 3 to the terminal station STA1 using the beam pattern of sector number 0, and notifies the terminal station STA1 of the information.

The terminal station STA1 receives the feedback packet 708 using the beam patter of sector number 0, and determines that sector number 3 is optimum in transmission on the terminal station STA1 side for packets to be transmitted from the terminal station STA1 to the access point AP (step S634 of FIG. 9).

In both the access point AP and the terminal station STA1, the above operation selects the optimum beam pattern on the transmission side and sets the sector number as pattern information that indicates the transmitting sector directivity. In the example in FIG. 12, when data communication is started, the access point AP and the terminal station STA1 select the beam patter of sector number 3 for transmission, and perform transmission and reception of the packet 709.

Retuning to FIG. 7, the wireless communication device next performs procedures in steps S604 and S605 during the SLS period of the local station.

In step S604, the directivity control unit 203 of the wireless communication device makes a receiving sector directivity determination on the access point AP side. In step S605, the directivity control unit 203 of the wireless communication device makes a receiving sector directivity determination on the terminal station STA side. In the receiving sector directivity determinations, the procedures are performed in which the wireless communication device on the reception side switches sector numbers of beam patterns, predetermined packets are communicated, and a sector is determined which provides the highest reception level or a reception level higher than or equal to a predetermined value on the reception side.

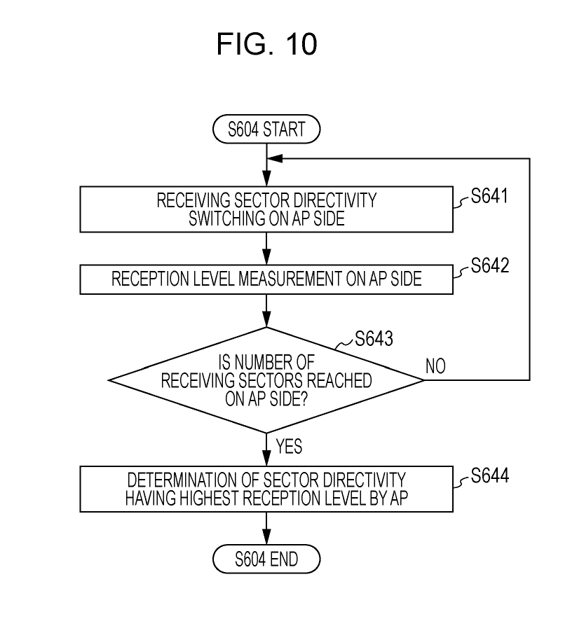

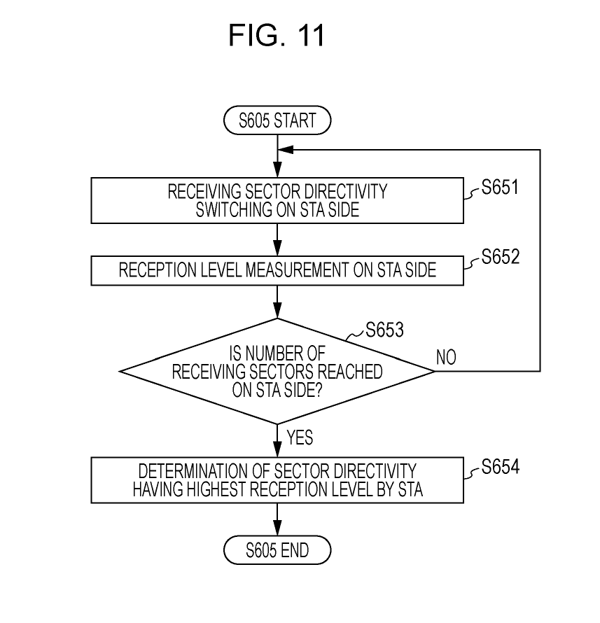

FIG. 10 is a flowchart illustrating an operating procedure for a receiving sector directivity determination on the access point AP side in step S604 of FIG. 7. FIG. 11 is a flowchart illustrating an operating procedure for a receiving sector directivity determination on the terminal station STA side in step S605 of FIG. 7.

In the receiving sector directivity determination on the access point AP side in step S604, the wireless communication device on the access point AP side switches receiving sector directivities, receives packets transmitted from the terminal station STA side (step S641), measures reception levels of the received packets, and retains the measured values (step S642). Then, whether a predetermined number of receiving sectors switched on the access point AP side is reached is determined (step S643), and the receiving sector switching and reception level measurement in steps S641 and S642 are repeated until the predetermined number of receiving sectors is reached.

After the predetermined number of receiving sectors is reached in step S643, the wireless communication device of the access point AP determines a sector directivity that provides the highest reception level or a reception level higher than or equal to a predetermined value (step S644). Then, the access point AP notifies the terminal station STA of the sector number as a receiving sector directivity determination result, and both the access point AP and the terminal station STA retain the sector number as a receiving sector number on the access point AP side by the SLS. Thus, the receiving sector directivity determination on the access point AP side is completed.

In the receiving sector directivity determination on the terminal station STA side in step S605, the wireless communication device on the terminal station STA side switches receiving sector directivities, receives packets transmitted from the access point AP (step S651), measures reception levels of the received packets, and retains the measured values (step S652). Then, whether a predetermined number of receiving sectors switched on the terminal station STA side is reached is determined (step S653), and the receiving sector switching and reception level measurement in steps S651 and S652 are repeated until the predetermined number of receiving sectors is reached.

After the predetermined number of receiving sectors is reached in step S653, the wireless communication device of the terminal station STA determines a sector directivity that provides the highest reception level or a reception level higher than or equal to a predetermined value (step S654). Then, the terminal station STA notifies the access point AP of the sector number as a receiving sector directivity determination result, and both the terminal station STA and the access point AP retain the sector number as a receiving sector number on the terminal station STA side by the SLS. Thus, the receiving sector directivity determination on the terminal station STA side is completed.

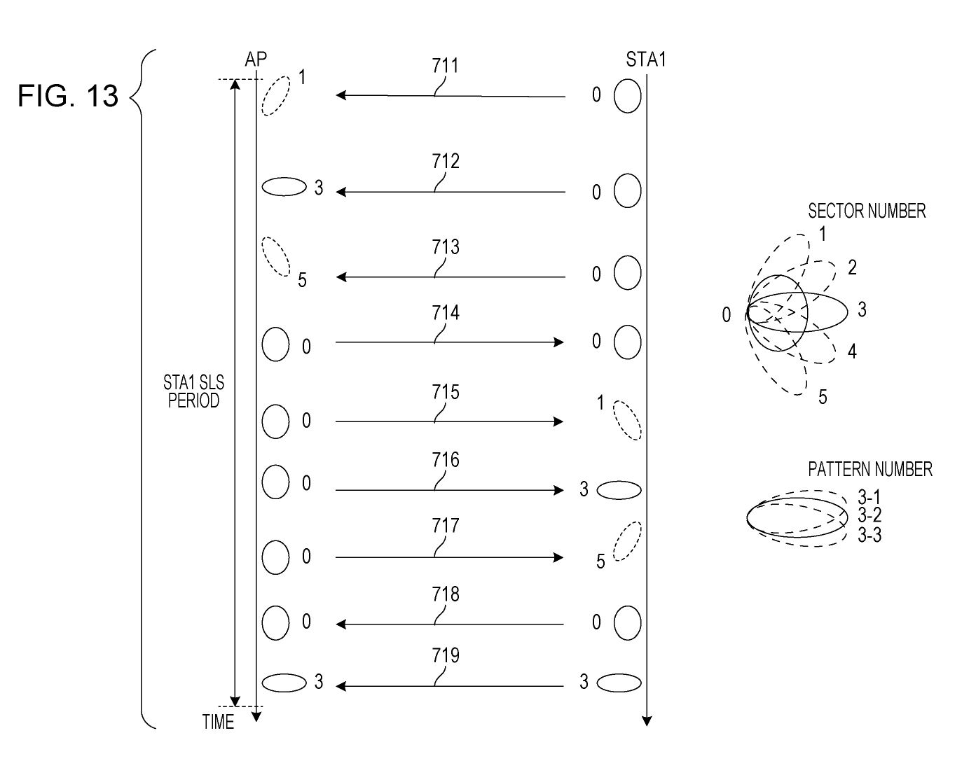

FIG. 13 illustrates time-series changes in the packet switching and directivity when a receiving sector directivity determination is made during the SLS period of the local station. An example of the receiving sector directivity determination operation is illustrated here when the local station is the terminal station STA1, which performs the SLS with the access point AP, which is a communication counterpart station.

In FIG. 13, the time flows from the top to the bottom, packets 711 to 719 indicate directions of transmitted packets by arrows, and which beam pattern is used for transmission or reception by each of the access point AP and the terminal station STA1 is indicated, as in FIG. 12.

The selection of a sector number to be used for reception by the access point AP will be described. First, the terminal station STA1 transmits the packet 711 using the beam pattern of sector number 0 (quasi-omni). The access point AP receives the packet 711 using the beam pattern of sector number 1, and measures and saves the reception quality, for example, a reception level of the received packet. The packet 711 contains directivity patter information that indicates which sector number is used for transmission.

Then, the terminal station STA1 transmits the packet 712 using the beam pattern of sector number 0, and the access point AP receives the packet 712 using the beam pattern of sector number 3, and measures and saves the reception quality of the received packet. Further, the terminal station STA1 transmits the packet 713 using the beam pattern of sector number 0, and the access point AP receives the packet 713 using the beam patter of sector number 5, and measures and saves the reception quality of the received packet. The transmission and reception of the packets 711 to 713 correspond to the operation in steps S641 to S643 of FIG. 10.

The access point AP determines the packet with the highest reception quality among the above received packets and selects the best beam pattern. Alternatively, the access point AP selects the beam pattern that provides reception quality higher than or equal to a predetermined value. For example, when the packet received using the beam patter of sector number 3 has the highest reception quality, the access point AP transmits the feedback packet 714 containing directivity patter information of sector number 3 to the terminal station STA1 using the beam pattern of sector number 0, and notifies the terminal station STA1 of the information.

The terminal station STA1 receives the feedback packet 714 using the beam patter of sector number 0, and determines that sector number 3 is optimum in reception on the access point AP side for packets to be transmitted from the terminal station STA1 to the access point AP (step S644 of FIG. 10).

The selection of a sector number to be used for reception by the terminal station STA1 will next be described. The access point AP transmits the packet 715 using the beam patter of sector number 0. The terminal station STA1 receives the packet 715 using the beam pattern of sector number 1, and measures and saves the reception quality, for example, a reception level of the received packet. As in the above packets 711 to 713, the packet 715 contains directivity pattern information that indicates which sector number is used for transmission.

Then, the access point AP transmits the packet 716 using the beam pattern of sector number 0, and the terminal station STA1 receives the packet 716 using the beam pattern of sector number 3, and measures and saves the reception quality of the received packet. Further, the access point AP transmits the packet 717 using the beam pattern of sector number 0, and the terminal station STA1 receives the packet 717 using the beam pattern of sector number 5, and measures and saves the reception quality of the received packet. The transmission and reception of the packets 715 to 717 correspond to the operation in steps S651 to S653 of FIG. 11.

The terminal station STA1 determines the packet with the highest reception quality among the above received packets and selects the best beam pattern. Alternatively, the terminal station STA1 selects the beam pattern that provides reception quality higher than or equal to a predetermined value. For example, when the packet received using the beam pattern of sector number 3 has the highest reception quality, the terminal station STA1 transmits the feedback packet 718 containing directivity pattern information of sector number 3 to the access point AP using the beam pattern of sector number 0, and notifies the access point AP of the information.

The access point AP receives the feedback packet 718 using the beam pattern of sector number 0, and determines that sector number 3 is optimum in reception on the terminal station STA1 side for packets to be transmitted from the access point AP to the terminal station STA1 (step S654 of FIG. 11).

In both the access point AP and the terminal station STA1, the above operation selects the optimum beam pattern on the reception side and sets the sector number as pattern information that indicates the receiving sector directivity. In the example in FIG. 13, when data communication is started, the access point AP and the terminal station STA1 select the beam pattern of sector number 3 for reception, and perform transmission and reception of the packet 719.

In FIG. 7, the procedures in steps S602, S603, S604, and S605 may be performed in any order.

The sector number selection has been described in FIGS. 12 and 13. After the sector number is decided, the reception characteristics are improved by further selecting a pattern number.

The wireless communication device performs steps S602 to S605 during the SLS period of the local station, and decides the beam patterns on the transmission and reception sides that provide the highest reception quality between the local station and the communication counterpart station. Then, the wireless communication device switches the communication sector directivities such that the beam patterns of the set sector numbers are provided for transmission and reception (step S611). Thus, the SLS before the start of communication in the wireless communication device is completed.

### Directivity Control Operation Using an Interference Signal

On the other hand, when the MAC unit 201 determines that the local station is not in the SLS period in step S601 of FIG. 7, the MAC unit 201 next determines whether another station is in a communication period (step S607). As the communication period of the other station, a period during which the other station performs an SLS or a period during which the other station performs communication on a priority basis through band reservation is determined, for example.

When the other station is in the communication period in step S607, the wireless communication device on the terminal station STA side uses the receiving unit 208 to intercept communication in the other station, and uses the reception quality estimation unit 209 to measure the reception quality, for example, a reception level of a received signal that is directed to the other station and is an interference signal (step S608).

When received signals are in the same format, the receiving unit 208 can determine the signal directed to the other station by, for example, analyzing the preambles or headers of the received signals. When the received signals are in different formats, the signals are determined as interference signals because the signals are not directed to the local station.

Next, the wireless communication device on the terminal station STA side uses the directivity control unit 203 to determine an intra-sector directivity pattern that lowers the reception level of the interference signal, based on the measured reception quality of the interference signal (step S609).

In the intra-sector directivity pattern determination, the directivity control unit 203 changes a pattern number in directivity pattern information of which notification is provided to the directivity switching unit 207, changes an intra-sector beam pattern, and determines a beam directivity for improving the characteristics in a direction in which the interference level is lowered as a direction in which an influence of the interference is reduced.

Then, the wireless communication device on the terminal station STA side switches intra-sector directivity patterns such that the influence of the interference is reduced, in accordance with a directivity determination result (step S610). At this time, the directivity control unit 203 changes the setting of the pattern number in the directivity pattern information and fine-sets the directivity in the direction in which the interference level is lowered, thereby switching the intra-sector beam patterns on the terminal station STA side. When the directivity is fine-set, a method is used, for example, in which beam patterns of a plurality of pattern numbers are switched in order, and the best pattern number for which the influence of the interference is small is selected or a pattern number for which the interference level is smaller than or equal to a predetermined threshold value is selected.

Subsequently, the wireless communication device returns to step S607, repeats steps S607 to S610 for the period during which the other station continues communication, and controls the directivity in the direction in which the interference level is lowered. For example, to reduce the influence of interference on the local station to the lowest level, the directivity is adjusted during the communication period of the other station.

The wireless communication device completes the processing in FIG. 7 when the local station is not in the SLS period in step S601 and the other station is not in the communication period in S607.

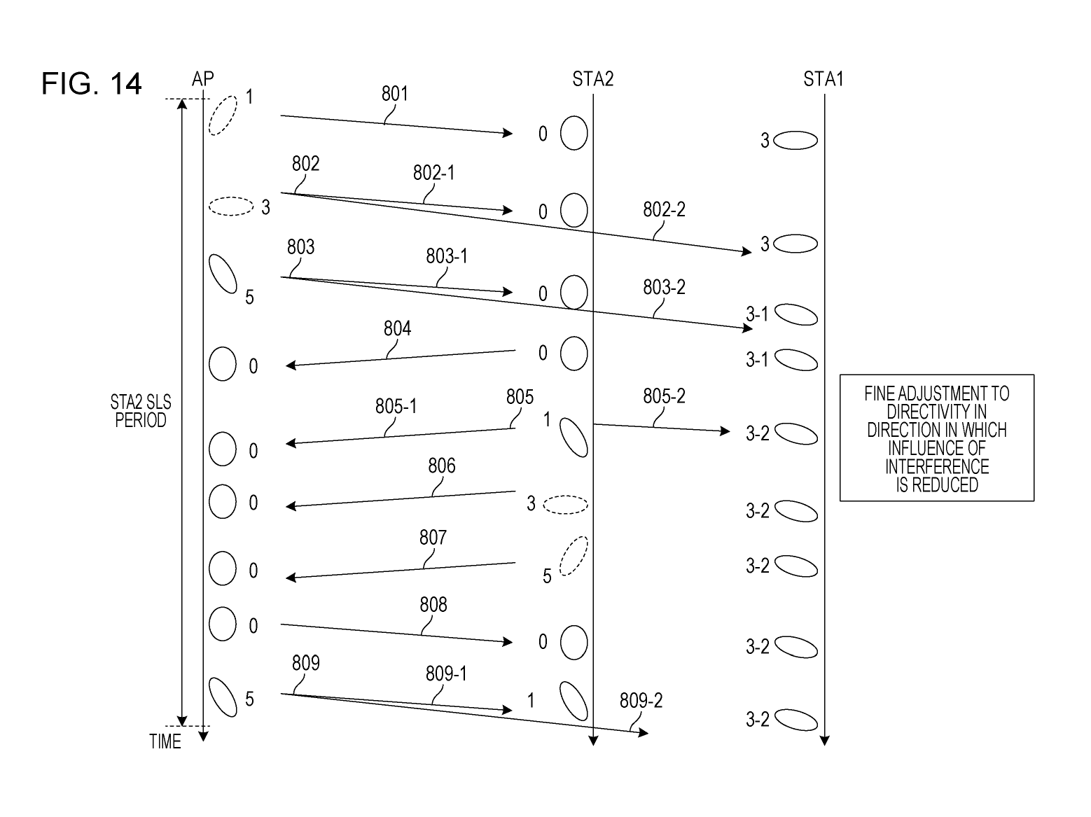

FIG. 14 illustrates time-series changes in the packet switching and directivity when intra-sector directivity control is performed during an SLS period of another station. An example of the intra-sector directivity control operation is illustrated here when the local station is the terminal station STA1 and the other station is the terminal station STA2, which performs the SLS with the access point AP.

In FIG. 14, the time flows from the top to the bottom, packets 801 to 809 indicate directions of transmitted packets by arrows, and which beam patter is used for transmission or reception by each of the access point AP and the terminal stations STA1 and STA2 is indicated, as in FIGS. 12 and 13.

As in FIGS. 12 and 13, the access point AP and the terminal station STA2 switch the beam patterns of sector numbers 1, 3, and 5 in order, transmit and receive the packets 801, 802, 803, 805, 806, and 807, determine the packets with the highest reception quality, and selects the best beam patterns. Then, the feedback packets 804 and 808 are used to notify the communication counterpart stations of directivity pattern information containing the selected sector numbers.

A case where the access point AP and the terminal station STA2 make transmitting sector directivity determinations is illustrated here; for example, the access point AP selects sector number 5 and the terminal station STA2 selects sector number 1 as optimum beam patterns, respectively. At this time, the terminal station STA1 has already completed the SLS with the access point AP, and has selected sector number 3 as a beam pattern on the reception side.

When the terminal station STA1 determines the start of an SLS of the terminal station STA2 as a communication period of the other station, the terminal station STA1 intercepts packets transmitted and received between the access point AP and the terminal station STA2. For example, the packet 802 is transmitted from the access point AP to the terminal station STA2 and is received as a packet 802-1 by the terminal station STA2, while the packet 802 is also received as a packet 802-2 by the terminal station STA1.

Because the received packet 802-2 is not a packet directed to the local station, the terminal station STA1 determines the packet 802-2 as an interference packet (interference signal) for the local station. At this time, the terminal station STA1 measures the reception quality, for example, a reception level of the interference signal, determines a directivity patter in a direction in which an influence of interference is reduced, for example, a direction in which the reception level of the interference signal is lowered, and fine-sets the directivity. The terminal station STA1 selects pattern number 3-1 here as a fine-setting to the directivity for lowering the reception level of the interference signal and continues reception of packets directed to the other station.

When the packet 803 is transmitted from the access point AP to the terminal station STA2, the packet 803 is received as a packet 803-1 by the terminal station STA2, while the packet 803 is received as an interference packet 803-2 by the terminal station STA1. As in the last time, the terminal station STA1 determines a directivity pattern in a direction in which an influence of interference is reduced. Pattern number 3-1 is selected here, which is the same as the last time.

Then, the packet 805 is transmitted from the terminal station STA2 to the access point AP and received as a packet 805-1 by the access point AP, while the packet 805 is received as an interference packet 805-2 by the terminal station STA1. For transmission from the terminal station STA2, the terminal station STA1 similarly determines a directivity pattern in a direction in which an influence of interference is reduced. Pattern number 3-2 is selected here as a fine-setting to the directivity for lowering the reception level of the interference signal.

Subsequently, the terminal station STA2 and the access point AP complete the SLS and data communication is started. When the packet 809 is transmitted from the access point AP, a packet 809-1 is received by the terminal station STA2 through the beam pattern of sector number 1. On the other hand, an interference packet 809-2 is received by the terminal station STA1, but the reception level of the interference signal is lowered because the beam pattern of pattern number 3-2 is selected.

The terminal station STA1 fine-sets the directivity as needed in the direction in which the interference level is lowered during the communication period of the other station, and decides the pattern number of the directivity after the fine-setting in consideration of the interference.

In the wireless communication device and the directivity control method of the present embodiment, when beamforming training is performed before the start of communication, communication signals directed to another station that are interference signals are received during a communication period of the other station, and a directivity is fine-set in a direction in which an influence of interference is reduced. The directivity control of the present embodiment enables autonomous interference avoidance with small overhead in consideration of interference from another device.

According to the present embodiment, in a determination of a directivity that provides excellent reception quality, it is possible to prevent an erroneous selection of a directivity in which a reception level is raised and interference becomes large due to, for example, the addition of desired waves and overlapping interference wave, and autonomous interference avoidance is enabled with small overhead.

Various aspects of embodiments according to the present disclosure include the following.

A wireless communication device of the present disclosure includes a directivity control unit that sets a directivity for a plurality of antennas, a directivity switching unit that switches the directivity for the plurality of antennas, and a reception quality estimation unit that measures the reception quality of a received signal received by the plurality of antennas. The directivity control unit uses the reception quality of a received signal directed to another station among the received signals to adjust the directivity in a direction in which an influence of interference from the other station is reduced.

The above wireless communication device may be a wireless communication device in which the directivity control unit further uses the reception quality of a received signal directed to a local station among the received signals to adjust the directivity in a direction in which the reception quality is higher than or equal to a predetermined value.

The above wireless communication device may be a wireless communication device in which the directivity control unit uses the reception quality of the received signal directed to the local station among the received signals to coarse-set the directivity and uses the reception quality of the received signal directed to the other station among the received signals to fine-set the directivity.

A directivity control method of the present embodiment measures the reception quality of a received signal received by a plurality of antennas and uses the reception quality of a received signal directed to another station among the received signals to adjust the directivity in a direction in which an influence of interference from the other station is reduced.

The above directivity control method may be a directivity control method in which for the adjustment to the directivity, before the adjustment to the directivity using the reception quality of the received signal directed to the other station, the reception quality of a received signal directed to a local station among the received signals is used to adjust the directivity in a direction in which the reception quality is higher than or equal to a predetermined value.

The above directivity control method may be a directivity control method in which for the adjustment to the directivity, the reception quality of the received signal directed to the local station among the received signals is used to coarse-set the directivity and the reception quality of the received signal directed to the other station among the received signals is used to fine-set the directivity.

Although various embodiments have been described above with reference to the drawings, it is obvious that the present disclosure is not limited to such examples. It is apparent that those skilled in the art would be able to conceive various examples of changes or modifications within the scope indicated in the claims, and it should be appreciated that these examples are also included in the technical scope of the present disclosure. Any combinations of the components in the above embodiments may be made without departing from the spirit of the present disclosure.

The above embodiments have been described with an example in which the present disclosure is configured with hardware. However, the present disclosure may also be implemented with software in cooperation with the hardware.

The functional blocks used to describe the above embodiments are typically implemented as LSI chips, which are integrated circuits. An each individual functional block may be contained on a single LSI chip, or some or all functional blocks may be contained on a single LSI chip. The integrated circuit technique is LSI here, but may be referred to as IC, system LSI, super LSI, or ultra LSI depending on a difference in a degree of integration.

The integrated circuit technique is not limited to LSI, and the functional blocks may be implemented using dedicated circuits or general-purpose processors. After the manufacture of LSI chips, field programmable gate arrays (FPGAs), or reconfigurable processors with which the connection and setting of circuit cells inside the LSI chips are reconfigurable may be used.

In addition, if an integrated circuit technology that replaces LSI emerges with the advance of the semiconductor technology or with the advent of another derivative technology, it should be appreciated that the functional blocks may be integrated using that technology. There is a possibility of, for example, applying the biotechnology.

The present disclosure may be represented as a directivity control method performed in a wireless communication device. The present disclosure may also be represented as a directivity control device used as a device having the function of performing the directivity control method or represented as a program with which a computer operates the directivity control method or directivity control device. That is, the present disclosure may be represented in any of the device, method, and program categories.

The present disclosure has an effect of enabling autonomous interference avoidance in consideration of interference from another device, and is useful as, for example, a wireless device for millimeter-wave wireless communication that performs autonomous directivity control and data communication, a directivity control method for use in the wireless device, and so on.

What is claimed is:

1. A wireless communication device comprising:
a directivity control unit that sets a directivity for a plurality of antennas;
a directivity switching unit that switches the directivity for the plurality of antennas; and
a reception quality estimation unit that measures reception quality of a received signal received by the plurality of antennas,
wherein the directivity control unit uses reception quality of a received signal directed to another station among the received signals to set the directivity in a direction in which an influence of interference from the other station is reduced.

2. The wireless communication device according to claim 1,
wherein the directivity control unit further uses reception quality of a received signal directed to a local station among the received signals to set the directivity in a direction in which the reception quality is higher than or equal to a predetermined value.

3. The wireless communication device according to claim 2,
wherein the directivity control unit uses the reception quality of the received signal directed to the local station among the received signals to coarse-set the directivity and uses the reception quality of the received signal directed to the other station among the received signals to fine-set the directivity.

4. A directivity control method comprising:
measuring reception quality of a received signal received by a plurality of antennas; and
using reception quality of a received signal directed to another station among the received signals to adjust a directivity in a direction in which an influence of interference from the other station is reduced.

5. The directivity control method according to claim 4,
wherein for the adjustment to the directivity, before the adjustment to the directivity using the reception quality of the received signal directed to the other station, reception quality of a received signal directed to a local station among the received signals is used to adjust the directivity in a direction in which the reception quality is higher than or equal to a predetermined value.

6. The directivity control method according to claim 5,
wherein for the adjustment to the directivity, the reception quality of the received signal directed to the local station among the received signals is used to coarse-set the directivity and the reception quality of the received signal directed to the other station among the received signals is used to fine-set the directivity.
